(19) United States
(12) Patent Application Publication
(10) Pub. No.: US 2011/0214273 A1
(43) Pub. Date: Sep. 8, 2011

(54) FASTENER REMOVAL DEVICE AND METHOD

(75) Inventors: Thomas J. Olson, JR., Kirkland, WA (US); Brian A. Kester, Kirkland, WA (US)

(73) Assignee: GENI INDUSTRIES, INC., Redmond, WA (US)

(21) Appl. No.: 12/715,537

(22) Filed: Mar. 2, 2010

(51) Int. Cl. B23P 19/04; B23P 11/00

(52) U.S. Cl. 29/426.5; 29/259; 29/256

(57) ABSTRACT

According to an embodiment of the present disclosure, a fastener removal device for removing a fastener from an apparatus includes a support structure and an extractor assembly movably associated with the support structure. The extractor assembly may include a collet configured to grip the fastener. The device further includes a turning mechanism associated with the extractor assembly. The turning mechanism is configured to rotate the extractor assembly with respect to the support structure.

### TECHNICAL FIELD

The invention relates to a fastener removal device and to a method of removing a fastener from an apparatus.

### BACKGROUND

Prior methods of removing industrial fasteners, such as link pins, may involve use of sledge hammers or torches. Such manual methods may require great strength and effort, and may take several hours to complete.

When using a hammer, several individuals may be required. For example, one person may hold a striking rod seated on a pin to be removed, a second person may hammer the rod, and a third person may receive the pin, which may weigh up to 40 pounds or more. A chemical solvent, such as a degreaser, may also be applied to the pin prior to application of hammer force to facilitate pin removal.

Alternatively, a torch may be used to penetrate the inside of a pin to be removed, which causes the exterior diameter of the pin to increase temporarily. After the pin has sufficiently cooled, the exterior diameter of the pin may reduce in size such that the pin will become loose and can then be removed. Use of a torch, however, requires a specialized individual, a gas supply nearby, and certain safety equipment. Because of the potential proximity to hydraulic oil and gasoline, a fire watch may also be needed.

### SUMMARY

According to an embodiment of the present disclosure, a fastener removal device for removing a fastener from an apparatus includes a support structure and an extractor assembly movably associated with the support structure. The extractor assembly may include a collet configured to grip the fastener. The device further includes a turning mechanism associated with the extractor assembly. The turning mechanism is configured to rotate the extractor assembly with respect to the support structure.

A method of removing a fastener from an apparatus may include moving a collet relative to a collet cap such that the collet cap engages the collet and causes the collet to grip the fastener. The method may also include moving the collet cap and the collet away from the apparatus and with respect to a support structure after the collet has gripped the fastener, wherein the support structure supports the collet cap and collet. In addition, the method may include rotating the collet cap and the collet with respect to the support structure after the collet has gripped the fastener.

Still further, a fastener removal device for removing a fastener from an apparatus may include an inanimate support structure and an extractor assembly movably associated with the support structure. The extractor assembly may include a gripper arrangement configured to grip the fastener, and an extraction member configured to move the gripper arrangement and fastener along a longitudinal axis of the extractor assembly. The device may further include a turning mechanism associated with the extractor assembly. The turning mechanism may be configured to rotate the extractor assembly about the longitudinal axis and with respect to the support structure.

While exemplary embodiments are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a perspective view of a fastener removal device according to the present disclosure, wherein the fastener removal device includes a support structure, an extractor assembly supported by the support structure; and a turning mechanism for rotating the extractor assembly with respect to the support structure;

FIG. 2 is a side view of the fastener removal device with the support structure shown partially in schematic form;

FIG. 3 is a perspective view of the extractor assembly and turning mechanism, with a portion of the turning mechanism broken away to show a drive member of the turning mechanism;

FIG. 4 is a cross-sectional view of the fastener removal device;

FIG. 5 is an enlarged fragmentary, cross-sectional view of the extractor assembly including a collet and collet cap, wherein the collet is shown in a disengaged position with respect to the collet cap;

FIG. 6 is an enlarged fragmentary, cross-sectional view of the extractor assembly, showing the collet in an engaged position with respect to the collet; and

FIG. 7 is a top cross-sectional view of the extractor assembly showing a slider of the extractor assembly in a retracted position.

### DETAILED DESCRIPTION

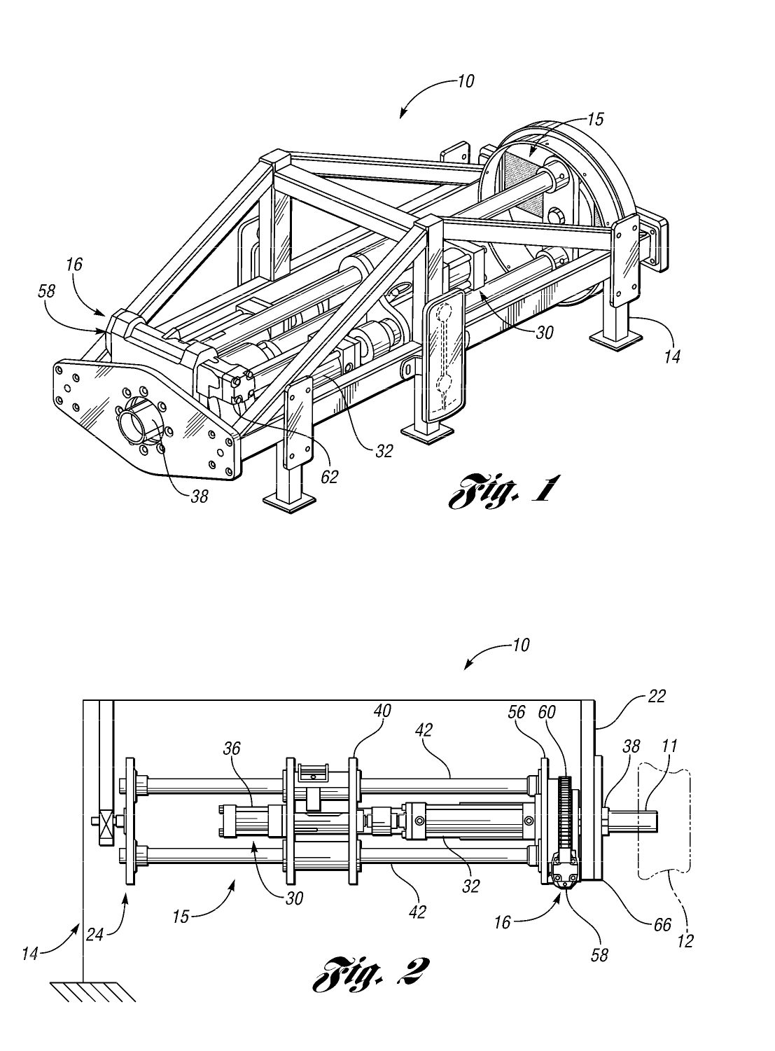

The present disclosure describes various apparatuses and methods for removing fasteners from industrial apparatuses, for example. Several specific embodiments are set forth in the following description and in FIGS. 1-7 to provide a thorough understanding of certain embodiments according to the present disclosure. As those of ordinary skill in the art will understand, various features of the embodiments illustrated and described with reference to any one of the Figures may be combined with features illustrated in one or more other Figures to produce embodiments that are not explicitly illustrated or described. In addition, other embodiments may be practiced without several of the specific features explained in the following description.

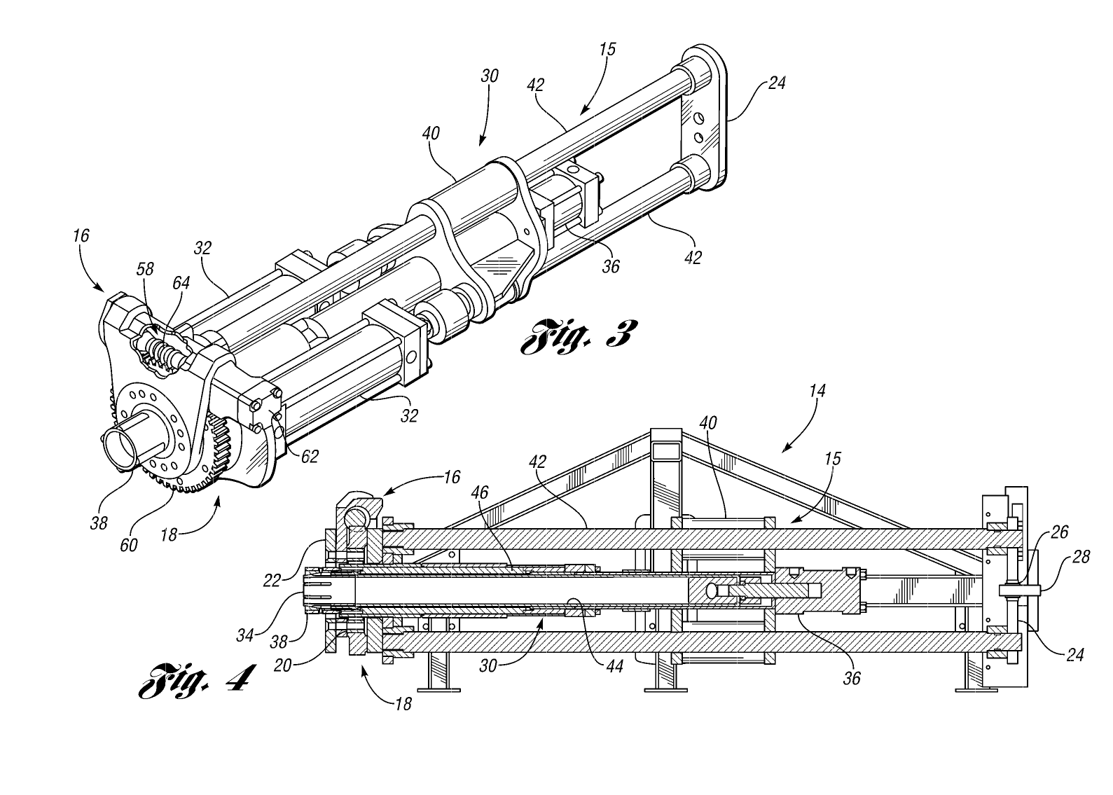

FIGS. 1 and 2 show a fastener removal device 10 according to the present disclosure. The device 10 may be used to remove a fastener 11, such as a link pin or rod, from any suitable apparatus 12, such as an aerial work platform, bulldozer, backhoe, or excavation equipment. As a more detailed example, the fastener 11 may be a link pin that connects two sections of an articulated boom or telescopic boom of an aerial work platform. Furthermore, the fastener 11 may be relatively large. For example, the fastener 11 may have a length in the range of approximately 6 to 35 inches, a diameter in the range of approximately 1.5 to 2.5 inches, and a mass in the range of approximately 0.5 to 20 kilograms. As another example, the fastener 11 may have a length in the range of 4 to 40 inches, a diameter in the range of 1 to 3 inches, and a mass in the range of 0.3 to 25 kilograms.

In the embodiment shown in FIGS. 1 and 2, the device 10 includes a support structure 14, an extractor assembly 15 movably associated with the support structure 14, and a turning mechanism 16 associated with the extractor assembly 15. The support structure 14 may be a frame or any other suitable support arrangement for supporting the extractor assembly 15 and turning mechanism 16 on a floor or any other support surface.

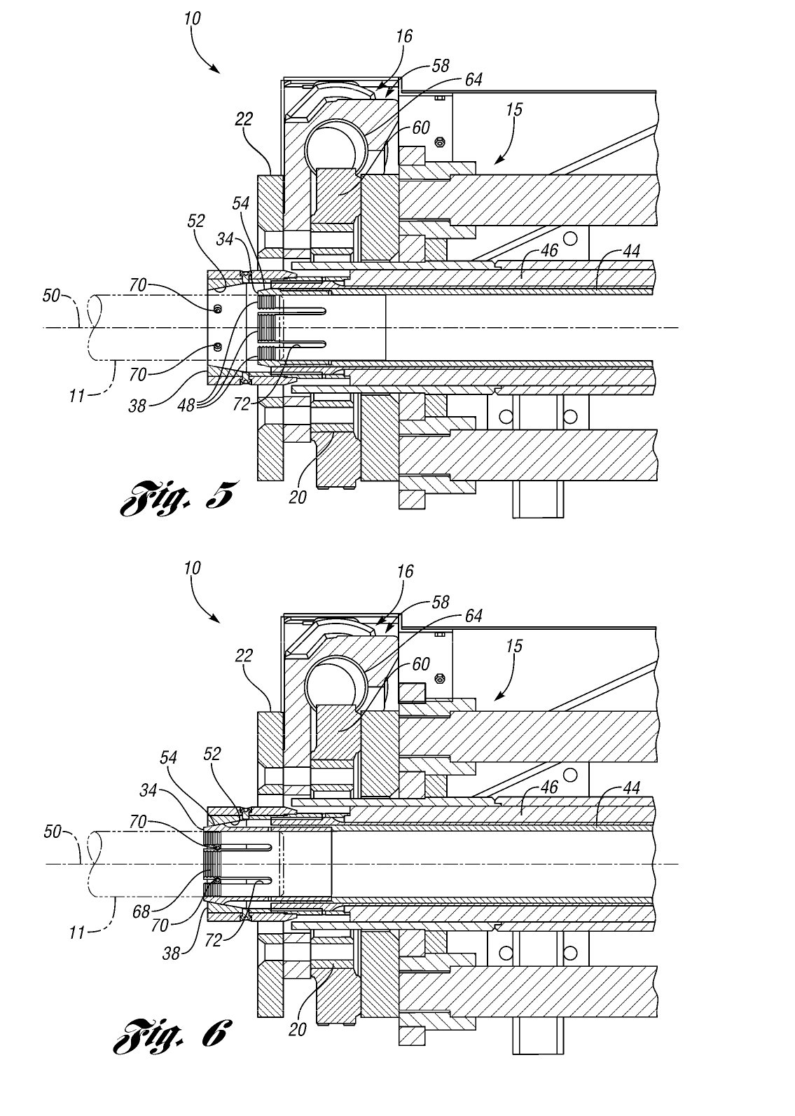

Referring to FIGS. 3 and 4, the extractor assembly 15 may be rotatably mounted on the support structure 14. For example, a first end 18 of the extractor assembly 15 may be rotatably supported on a first bearing 20 that is fixedly attached to a fixed plate 22 of the support structure 14, and a second end 24 of the extractor assembly 15 may be rotatably supported on a second bearing 26 that is mounted on a pin 28 attached to the support structure 14.

Furthermore, the extractor assembly 15 may be configured to grip and extract the fastener 11 from the apparatus 12. In the embodiment shown in FIGS. 1-4, for example, the extractor assembly 15 includes a gripper arrangement 30 for gripping the fastener, and one or more extraction members, such as extraction cylinders 32, for moving the gripper arrangement 30 once the gripper arrangement 30 has sufficiently gripped the fastener 11. While the gripper arrangement 30 and extraction members may have any suitable configuration, example configurations are described below in detail.

Referring to FIGS. 3 and 4, the gripper arrangement 30 may include a gripping member, such as a collar or collet 34, that is configured to grip the fastener 11, a locking or clamp cylinder 36 associated with the collet 34, and a clamp member, such as a collet cap 38, that cooperates with the collet 34 to facilitate gripping action of the collet 34. In the embodiment shown in FIGS. 3 and 4, the collet 34, clamp cylinder 36 and collet cap 38 are connected to a movable member, such as a slider 40, that is mounted on one or more guide members, such as guide rails or rods 42, that extend between the first and second ends 18 and 24, respectively, of the extractor assembly 15. For example, referring to FIGS. 4 and 5, the clamp cylinder 36 may have a base portion mounted on the slider 40, and a movable portion, such as a piston or plunger, that is connected to the collet 34 with a first connector member, such as a threaded inner tube 44 that is threaded onto the collet 34 and the movable portion of the clamp cylinder 36. In addition, the collet cap 38 may be connected to the slider 40 by a second connector member, such as an outer tube 46 that is disposed around the inner tube 44.

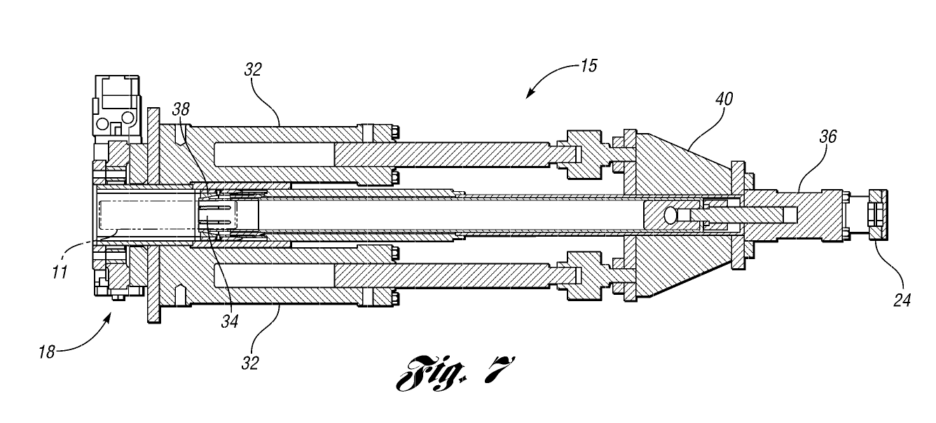

The clamp cylinder 36 is configured to move the collet 34 with respect to the collet cap 38 between a disengaged position, shown in FIG. 5, and an engaged position, shown in FIG. 6, so that the collet cap 38 may cause the collet 34 to clamp onto the fastener 11. In the embodiment shown in FIGS. 5 and 6, the collet 34 includes multiple gripping portions 48, such as movable legs, that are urged toward a central, longitudinal axis 50 when the collet 34 is urged into engagement with the collet cap 38. In that regard, the collet cap 38 may have one or more angled inner walls 52 that engage angled outer walls 54 of the gripping portions 48 when the collet 34 is urged toward the collet cap 38. For example, the walls 52 and 54 may extend at an angle in the range of 8 to 12 degrees with respect to a horizontal line. As another example, the walls 52 and 54 may each have a 10 degree taper angle. With such a configuration, the gripping portions 48 may clamp tightly around the fastener 11 when the collet 34 is urged into engagement with the collet cap 38, as shown in FIG. 6. For example, a pressure applied to the clamp cylinder 36 in the range of approximately 1,500 to 3,500 pounds per square inch (psi) may result in the gripping portions 48 exerting a clamping force in the range of approximately 12,400 to 29,000 pounds on the fastener 11. As another example, the gripping portions 48 may exert a clamping force of 1,200 pounds or more.

The collet 34 and collet cap 38 may have any suitable size and shape for gripping fasteners, such as the fastener 11. For example, the collet 34 may have an inner diameter of at least 1.5 inches, and the collet cap 38 may have an inner diameter of at least 2.8 inches.

In another embodiment, a gripping arrangement may be provided with a collet cap that is moved into engagement with a collet. For example, such a gripping arrangement may include a clamp cylinder that is connected to the collet cap and configured to move the collet cap with respect to the collet in order to cause the collet to grip a fastener to be removed.

As noted above, the extractor assembly 15 also includes one or more extraction members, such as extraction cylinders 32. In the embodiment shown in FIGS. 2 and 3, the extractor assembly 15 includes two extraction cylinders 32 that are configured as extension cylinders for moving the collet 34 and collet cap 38 with respect to the support structure 14 once the collet 34 has sufficiently gripped the fastener 11. Each extraction cylinder 32 has a first end mounted on a mounting member, such as a mounting plate 56 of the extractor assembly 15, and a movable second end such as a piston or plunger attached to the slider 40. The extraction cylinders 32 are operable to move the slider 40 along the guide rods 42 between a first or initial position, shown in FIG. 4, and a second or retracted position, shown in FIG. 7, in order to move the collet 34 and collet cap 38 with respect to an outer guide member disposed about the collet 34 and collet cap 38. In that regard, when the slider 40 is moved away from the mounting plate 56, the slider 40 pulls the collet cap 38 and collet 34 along the longitudinal axis 50 and away from the apparatus 12 from which the fastener 11 is being removed.

While the extraction cylinders 32 may be configured to move the slider 40 any suitable distance and exert any suitable force, in one embodiment the extraction cylinders 32 may be configured to move the slider 40 at least 10 inches along the guide rods 42 and exert an axial force of at least 10,000 pounds on the slider 40. As another example, the extraction cylinders 32 may exert an axial pulling force on the fastener 11 in the range of approximately 30,000 to 80,000 pounds.

As another example, the one or more extraction members may be provided as extraction cylinders that are positioned between the slider 40 and the second end 24 of the extractor assembly 15. With such an arrangement, the extraction cylinders may be configured to retract in order to move the slider 40, collet 34 and collet cap 38 away from the apparatus 12.

Referring to FIGS. 1 and 2, the turning mechanism 16 is configured to rotate the extractor assembly 15 with respect to the support structure 14 to facilitate removal of the fastener 11. While the turning mechanism 16 may have any suitable configuration, in the embodiment shown in FIGS. 1-3 and 5, the turning mechanism 16 includes a drive assembly 58 that is fixed to the fixed plate 22 of the support structure 14, and a driven member, such as a gear 60, fixedly attached to the extractor assembly 15. The drive assembly 58 may include a motor 62 and a drive gear 64 that is driven by the motor 62 and engageable with the gear 60. When the drive gear 64 is rotated by the motor 62, the drive gear 64 causes the gear 60 and extractor assembly 15 to rotate with respect to the support structure 14 and about the longitudinal axis 50 in a clockwise direction and/or a counter-clockwise direction.

In another embodiment, the turning mechanism 16 may include a drive assembly mounted on the extractor assembly 15, and a cooperating member such as a gear mounted on the support structure 14.

Referring to FIGS. 1-7, operation of the device 10 will now be described in more detail. First, the device 10 may be positioned over the fastener 11 to be removed, such that the fastener 11 extends into the gripper arrangement 30. Specifically, the device 10 may be axially aligned with the fastener 11 such that the fastener 11 extends into the collet 34. The support structure 14 of the device 10 may also be provided with wheels, rollers, or other movable members to facilitate positioning of the device 10. As shown in FIG. 2, the support structure 14 may also be provided with a pad 66 that is configured to rest against the apparatus 12.

Next, the clamp cylinder 36 may be activated to move the collet 34 into engagement with the collet cap 38, so that the gripping portions 48 move toward each other and grip the fastener 11, as shown in FIG. 6. The collet 34 may also be provided with serrations or grooves 68 to facilitate gripping of the fastener 11.

The extension cylinders 32 may then be activated to move the slider 40, collet 34 and collet cap 38 along the longitudinal axis 50 and away from the apparatus 12. As a result, the collet 34 may pull the fastener 11 away from the apparatus 12. The extension cylinders 32 may also initially cause the collet cap 38 to move with respect to the collet 34 and away from the apparatus 12, such that the collet cap 38 causes the collet 34 to exert a greater clamping force on the fastener 11. In that regard, the clamp cylinder 36 and/or other components of the gripper arrangement 30 may be configured to allow some relative movement of the collet cap 38 with respect to the collet 34 when the collet 34 is gripped onto the fastener 11.

Before, during and/or after activation of the extension cylinders 32, the turning mechanism 16 may also be activated to rotate the extractor assembly 15. Such rotational movement may facilitate removal of the fastener 11 from the apparatus 12. For example, the rotational movement may reduce friction between the fastener 11 and the apparatus 12. Furthermore, the turning mechanism 16 may rotate the extractor assembly 15 through any suitable angle in a clockwise direction and/or a counterclockwise direction, and may exert any suitable torque on the extractor assembly 15. For example, the turning mechanism 16 may rotate the extractor assembly 15 through an angle greater than or equal to 25 degrees, 45 degrees, or 75 degrees, and may exert a torque on the extractor assembly 15 of at least 3,000 foot-pounds.

The gripper arrangement 30 may also be configured to inhibit relative rotational movement between the collet 34 and collet cap 38 when the turning mechanism 16 is activated. For example, the gripper arrangement 30 may include one or more anti-rotation members that are associated with the collet 34 and/or collet cap 38. As a more detailed example, the collet cap 38 and/or outer tube 46 may include one or more engagement members, such as pins 70, that are slidingly received in one or more slots or grooves 72 formed in the collet 34 and/or inner tube 44 when the collet 34 is moved to the engaged position shown in FIG. 6. Such grooves 72 may be disposed between the gripping portions 48 of the collet 34, or may be formed in an outer surface of the collet 34 for instance. If the grooves 72 are disposed between the gripping portions 48, the pins 70 and grooves 72 may be configured to allow the gripping portions 48 to move toward each other in order to grip the fastener 11. For example, each pin 70 may have a diameter that is sufficiently smaller than the width of a corresponding groove 72 when the collet 34 is in the disengaged position, such that the gripping portions 48 may move toward the axis 50, and thereby reduce the width of the grooves 72 at their distal ends, when the collet 34 is moved to the engaged position.

As another example of a configuration for inhibiting relative rotational movement between the collet 34 and collet cap 38, the collet 34 and/or inner tube 44 may include one or more engagement members that are slidinglly received in one or more slots or grooves formed in the collet cap 38 or outer tube 46.

The device 10 may be controlled in any suitable manner. For example, the device 10 may be activated using a device-mounted electronic controller, a remote handheld electronic controller, or any other suitable control apparatus. Furthermore, each of the clamp cylinder 36, extension cylinders 32 and the turning mechanism 16 may be activated separately by actuating separate control elements, such as buttons or switches, associated with the above components.

As another example, a single control element may be used to initially activate the clamp cylinder 36, and then activation of the extension cylinders 32 and/or turning mechanism 16 may occur automatically. As a more detailed example, once the clamp cylinder 36 has reached a predetermined position, such as fully extended, the extension cylinders 32 may be automatically activated to exert a pulling force on the fastener 11. Furthermore, if the fastener 11 does not move a sufficient or predetermined distance in a predetermined amount of time, the extension cylinders 32 may automatically retract and then extend again to exert one or more additional pulls on the fastener 11. Alternatively or supplementally, the turning mechanism 16 may be automatically activated if the fastener 11 does not move a predetermined distance in a predetermined amount of time. The turning mechanism 16 may then twist or rotate the fastener 11 through any suitable angle in a clockwise direction and/or a counterclockwise direction in an effort to free the fastener 11 from the apparatus 12. For example, the turning mechanism 16 may twist or rotate the fastener 11 through an angle greater than or equal to 25 degrees, 45 degrees, or 75 degrees.

The device 10 according to the above disclosure may provide one or more advantages. For example, use of a handheld controller or remote controller may allow a device operator to be positioned away from the device 10 during operation. As another example, the device 10 may remove fasteners in a consistent, repeatable manner. Furthermore, the collet 34 may grip fasteners without causing damage to the fasteners. Still further, the collet 34 and collet cap 38 may be removed and replaced with collets and collet caps of different sizes and shapes to allow for removal of different sized fasteners. In addition, the rotational capabilities of the device 10 may enable removal of particularly stubborn fasteners. As yet another example, the inner tube 44 of the gripper arrangement 30 may function as a storage device or compartment for storing the fastener 11, as well as other fasteners, after removal.

The device 10 may be made of any suitable material and in any suitable manner. For example, the collet 34 and collet cap 34 may be made of high strength metal. As another example, the support structure 14 may be made of relatively lightweight metal, such as aluminum, or high strength, corrosion resistant material such as stainless steel.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various embodiments may be combined to form further embodiments of the invention.

What is claimed is:

1. A fastener removal device for removing a fastener from an apparatus, the fastener removal device comprising:
a support structure;
an extractor assembly movably associated with the support structure, the extractor assembly including a collet configured to grip the fastener; and
a turning mechanism associated with the extractor assembly, the turning mechanism being configured to rotate the extractor assembly with respect to the support structure.

2. The fastener removal device of claim 1 wherein the extractor assembly includes a collet cap and a clamp cylinder for moving one of the collet and the collet cap into engagement with the other of the collet and the collet cap.

3. The fastener removal device of claim 2 wherein the extractor assembly includes an extraction member associated with the collet cap for moving the collet cap and collet with respect to the support structure.

4. The fastener removal device of claim 3 wherein the extractor assembly includes a guide element and a slide element slidably mounted on the guide element, and wherein the clamp cylinder is attached to the slide element and the extraction member is configured to move the slide element along the guide element.

5. The fastener removal device of claim 4 wherein the extractor assembly includes a first connector member connected between the collet and the clamp cylinder, and a second connector member connected between the collet cap and the slide element.

6. The fastener removal device of claim 5 wherein the first connector member comprises an inner tube, and the second connector member comprises an outer tube disposed about the inner tube.

7. The fastener removal device of claim 1 wherein the extractor assembly has first and second ends that are supported by and rotatable with respect to the support structure.

8. The fastener removal device of claim 1 wherein the turning mechanism includes a motor and a drive gear attached to one of the support structure and the extractor assembly.

9. The fastener removal device of claim 1 wherein the turning mechanism includes a motor that is fixed to the support structure and a gear that is attached to the extractor assembly.

10. The fastener removal device of claim 1 wherein the extractor assembly is supported by the support structure and further includes a clamp cylinder associated with the collet, a collet cap that is engageable with the collet, and an extraction cylinder associated with the collet cap, wherein the clamp cylinder is configured to move the collet with respect to the collet cap such that the collet cap causes the collet to grip the fastener, and the extraction cylinder is configured to move the collet cap and collet with respect to the support structure to move the fastener away from the apparatus.

11. The fastener removal device of claim 1 wherein the extractor assembly further includes a collet cap that is engageable with the collet to facilitate gripping of the fastener, and an anti-rotation member associated with one of the collet and the collet cap for inhibiting relative rotation between the collet and collet cap.

12. A method of removing a fastener from an apparatus, the method comprising:
moving a collet relative to a collet cap such that the collet cap engages the collet and causes the collet to grip the fastener;
moving the collet cap and the collet away from the apparatus and with respect to a support structure after the collet has gripped the fastener, wherein the support structure supports the collet cap and the collet; and
rotating the collet cap and the collet with respect to the support structure after the collet has gripped the fastener.

13. The method of claim 12 wherein moving the collet cap and the collet away from the apparatus and rotating the collet cap and the collet are performed simultaneously.

14. The method of claim 12 wherein the step of moving the collet cap and the collet away from the apparatus is performed at least one of before and after the step of rotating the collet cap and the collet.

15. The method of claim 12 wherein one of the collet and the collet cap includes an anti-rotation member for inhibiting relative rotation between the collet and collet cap.

16. A fastener removal device for removing a fastener from an apparatus, the fastener removal device comprising:
an inanimate support structure;
an extractor assembly movably associated with the support structure, the extractor assembly including a gripper arrangement configured to grip the fastener, and an extraction member configured to move the gripper arrangement and fastener along a longitudinal axis of the extractor assembly; and
a turning mechanism associated with the extractor assembly, the turning mechanism being configured to rotate the extractor assembly about the longitudinal axis and with respect to the support structure.

17. The fastener removal device of claim 16 wherein the gripper arrangement includes a collet configured to grip the fastener, a collet cap and a clamp cylinder that is configured to move one of the collet and the collet cap relative to the other of the collet and the collet cap such that the collet cap facilitates gripping of the fastener.

18. The fastener removal device of claim 17 wherein the extraction member comprises an extraction cylinder associated with the collet cap for moving the collet cap and collet with respect to the support structure.

19. The fastener removal device of claim 16 wherein the turning mechanism includes a motor and drive gear attached to one of the support structure and the extractor assembly.

20. The fastener removal device of claim 16 wherein the turning mechanism includes a motor fixed to the support structure and a gear attached to the extractor assembly.
